(19) United States
(12) Patent Application Publication
(10) Pub. No.: US 2010/0070593 A1
(43) Pub. Date: Mar. 18, 2010

(54) VISUALIZING FEATURES OF MESSAGES COMMUNICATED BETWEEN USERS

(76) Inventors: Craig Peter Sayers, Menlo Park, CA (US); Tyler J. Close, Menlo Park, CA (US); Malena Rosa Mesarina, San Francisco, CA (US); Brett Bausk, Boulder Creek, CA (US); John Ludd Recker, Mountain View, CA (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/233,186

(22) Filed: Sep. 18, 2008

(51) Int. Cl. G06F 15/16; G06F 3/048

(52) U.S. Cl. 709/206; 715/733

(57) ABSTRACT

In a computerized method of visualizing features of messages communicated between a first user and a plurality of other users, a topic is identified and a visualization based upon messages containing at least one of the topic and a resource related to the topic is created. More particularly, the visualization is created to include at least one of user graphical representations and message graphical representations, and a resource graphical representation, such that, a user may easily identify features of the messages.

### BACKGROUND

Electronic mail (e-mail) and other types of computerized communication tools have ever-increasingly become dominant means by which users communicate with each other. In fact, it is now commonplace for users to receive dozens of messages in one or more message accounts every day ranging among a variety of different topics. As such, a user's inbox quickly becomes filled with numerous messages and thus becomes difficult to manage.

A common attempt at overcoming the difficulty in managing the messages is for the user to organize messages into a number of different folders. This requires that the user sort through the messages and place the messages into the appropriate folders, which is both time-consuming and laborious. This approach may be effective for those messages that pertain to a specific topic having a relatively long period of relevance, and can thus easily be sorted into the different folders. However, if a message is relevant to more than one topic and is thus suitable for insertion into multiple folders, the user may find it difficult to determine which of the folders that message is to be inserted. In addition, if the user receives a number of messages pertaining to a number of different topics, each having a relatively short period of relevance, the user will be required to create a relatively large number of new folders for each of the different topics, which is a relatively cumbersome task.

Users may relatively easily perform a search of their messages by manually inserting a known subject, name, keyword, date or email address into a search field. The e-mail or other computerized communication tool returns only those messages containing the inserted topic, typically in a list ordered by the sender's email address or by the date on which the messages were received. However, there may be many conversations related to a particular topic (each with a different subject and with different people on different days) and so the user may need to perform such searches repeatedly. Moreover, the results for each search are presented independently. As such, in order for a user to identify whether any of those messages are more relevant to the user in comparison with other messages, the user must manually review each of the messages to determine their respective relevance to a particular topic, which is both time-consuming and laborious.

It would therefore be desirable to be able to quickly and efficiently determine the respective relevance of messages pertaining to a particular topic without requiring the time consuming and laborious sorting operations currently being performed to manage electronic messages.

### BRIEF DESCRIPTION OF THE DRAWINGS

Features of the present invention will become apparent to those skilled in the art from the following description with reference to the figures, in which:

FIG. 1 shows a simplified block diagram of a system for visualizing features of messages communicated between a first user and a plurality of other users, according to an embodiment of the invention;

FIG. 2A depicts a diagram of a message feature visualization generated by the system depicted in FIG. 1, according to an example

FIG. 2B illustrates a screenshot of multiple sections of a browser display, including the message feature visualization depicted in FIG. 2A, according to an embodiment of the invention;

FIG. 3A illustrates a flow diagram of a method of visualizing features of messages communicated between a first user and a plurality of other users, according to an embodiment of the invention;

FIGS. 3B and 3C, respectively, depict partial flow diagrams of methods for visualizing features of messages communicated between a first user and a plurality of other users, which include steps that may be included in the method depicted in FIG. 3A, according to an embodiment of the invention; and

FIG. 4 shows a block diagram of a computing apparatus configured to implement one or more of the methods discussed with respect to FIGS. 3A-3C, according to an embodiment of the invention.

### DETAILED DESCRIPTION

For simplicity and illustrative purposes, the present invention is described by referring mainly to an exemplary embodiment thereof. In the following description, numerous specific details are set forth in order to provide a thorough understanding of the present invention. It will be apparent however, to one of ordinary skill in the art, that the present invention may be practiced without limitation to these specific details. In other instances, well known methods and structures have not been described in detail so as not to unnecessarily obscure the present invention.

Disclosed herein are a computerized method for visualizing features of messages communicated between a first user and a plurality of other users and an apparatus for performing the method. Also disclosed herein is a computer readable storage medium that contains a set of instructions for performing the method.

The features of the messages that are visualized, include, graphical representations of the first user and the other users, graphical representations of the messages and the senders and recipients of the messages, and graphical representations of resources related to an identified topic of the communications. The graphical representations provide information visually based upon one or more attributes assigned to the graphical representations. For instance, the users may be distinguished from each other through application of different colors to the graphical representations of the users.

Through implementation of the method and apparatus disclosed herein, a user may view the visualization to quickly determine the users involved in communications pertaining to a particular topic, the importance of the particular topic to the user, and when the communications occurred. The user may also use the visualization to quickly assess whether there are related resources to the particular topic. In addition, by consistently using the same attributes for the same users in different message feature visualizations, the user may also quickly identify the people to whom the graphical representations actually represent.

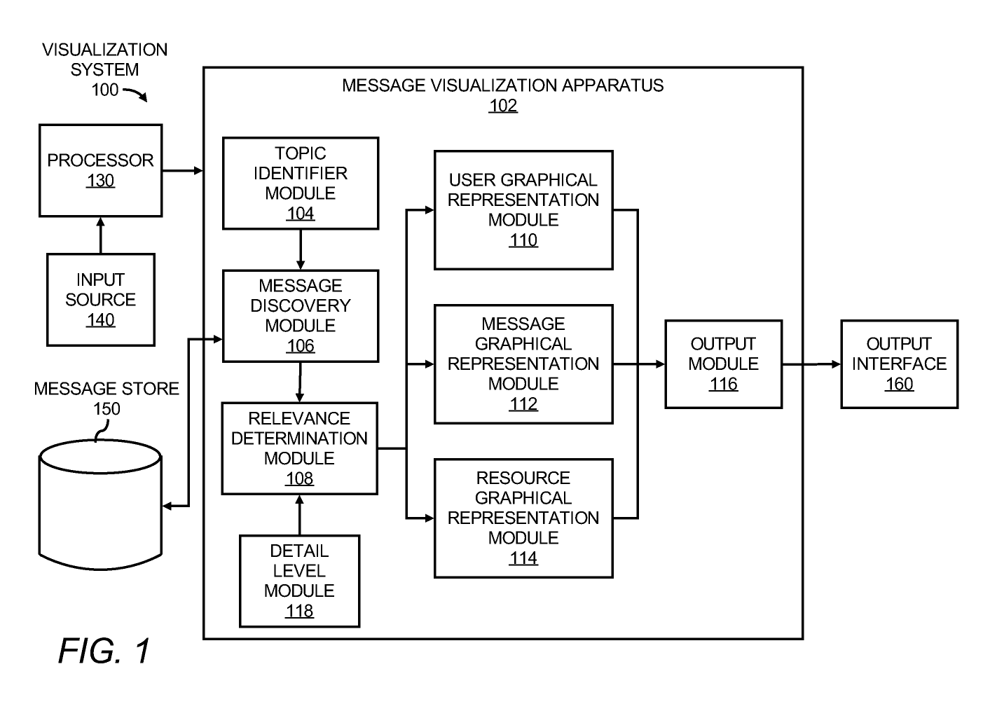

With reference first to FIG. 1, there is shown a simplified block diagram of a system 100 for visualizing features of messages communicated between a first user and a plurality of other users, according to an example. It should be understood that the system 100 may include additional components and that some of the components described herein may be removed and/or modified without departing from the scope of the system 100. For instance, the system 100 may include any number of additional applications or software configured to perform any number of other functions.

The visualization system 100 comprises a computing device, such as, a personal computer, a laptop computer, a tablet computer, a personal digital assistant, a cellular telephone, etc., configured with a message visualization apparatus 102, a processor 130, an input source 140, a message store 150, and an output interface 160. The processor 130, which may comprise a microprocessor, a micro-controller, an application specific integrated circuit (ASIC), and the like, is configured to perform various processing functions. One of the processing functions includes invoking or implementing the message visualization apparatus 102, and more particularly, the modules 104-118 of the message visualization apparatus 102, to visualize features of a plurality of messages communicated between a first user and a plurality of other users.

According to an example, the message visualization apparatus 102 comprises a hardware device, such as, a circuit or multiple circuits arranged on a board. In this example, the modules 104-118 comprise circuit components or individual circuits. According to another example, the message visualization apparatus 102 comprises software stored, for instance, in a volatile or non-volatile memory, such as DRAM, EEPROM, MRAM, flash memory, floppy disk, a CD-ROM, a DVD-ROM, or other optical or magnetic media, and the like. In this example, the modules 104-118 comprise software modules stored in the memory. According to a further example, the message visualization apparatus 102 comprises a combination of hardware and software modules.

The message visualization apparatus 102 may comprise a plug-in to a messaging application, which comprises any reasonably suitable application that enables communication over a network, such as, an intranet, the Internet, etc., through the visualization system 100, for instance, an e-mail application, a chat messaging application, a text messaging application, etc. In addition, or alternatively, the message visualization apparatus 102 may comprise a plug-in to a browser application, such as, a web browser, which allows access to webpages over an extranet, such as, the Internet or a file browser, which enables the user to browse through files stored locally on the user's visualization system 100 or through files stored externally, for instance, on a shared server. As a yet further example, the message visualization apparatus 102 may comprise a standalone apparatus configured to interact with a messaging application, a browser application, or another type of application.

As shown in FIG. 1, the message visualization apparatus 102 includes a topic identifier module 104, a message discovery module 106, a relevance determination module 108, a user graphical representation module 110, a message graphical representation module 112, a resource graphical representation module 114, an output module 116, and a detail level module 118. It should be understood that the message visualization apparatus 102 may comprise additional modules and that one or more of the modules 104-118 may be removed and/or modified without departing from a scope of the message visualization apparatus 102.

The topic identifier module 104 is configured to identify a desired topic. According to an example, the input source 140 may comprise an interface device through which a user may interact with the visualization system 100. In this example, the user may input the desired topic through the input source 140, which the processor 130 may communicate to the topic identifier module 104.

According to another example, the input source 140 may comprise a browser application or a messaging application from which the topic identifier module 104 may identify the desired topic. In this example, the topic identifier module 104 may automatically identify the topic based upon at least one identifier of a document displayed in the browser or a currently viewed message in the messaging application. By way of particular example, the topic identifier module 104 may automatically identify the topic based upon an identifier of the document displayed in the browser or an identifier cited in the document. The identifier may comprise, for instance, a Uniform Resource Identifier (URI), a Uniform Resource Locator (URL), a Uniform Resource Name (URN), or other machine-readable identifier, such as, a patent number, an ISBN, etc. As another particular example, the topic identifier module 104 may automatically identify the topic based upon an identifier cited in a particular message.

In any of the examples above, the topic identifier module 104 may communicate the identified topic to the message discovery module 106. The message discovery module 106 is configured to search through the message store 150, which comprises, for instance, a memory or other device that stores messages that are sent to and received by the first user, to discover messages containing the identified topic. The message store 150 may comprise a local memory, such as, a memory of the first user's personal computer. In this regard, the messages contained to the message store 150 may be privately owned by the first user. Alternatively, the message store 150 may be physically located on a computer server in an area only accessible to the first user, or the message store 150 may be formed from the union of several separate message stores which may be either public or private.

The relevance determination module 108 obtains various information pertaining to the discovered messages. For instance, the relevance determination module 108 obtains information used to determine the relevance of each of the other users to the first user. The information used to determine this relevance may include, for instance, the frequency with which the messages were sent, the number of messages that have been sent, whether the messages were sent directly to the recipients or whether the messages were indirectly sent to the recipients, such as by carbon-copying, when the messages were sent, whether the first user created the messages, etc.

The relevance determination module 108 may determine the relevance of the other users to the first user in either a topic-relevant or a topic-neutral manner. More particularly, the relevance determination module 108 may determine the relevance of the other users to the first user based upon the messages that contain the identified topic (topic-relevant) or, the relevance determination module 108 may determine the relevance based upon all of the messages communicated to and from the other users (topic-neutral).

The relevance determination module 108 may compute a score for each of the other users based upon a weighted combination of the various factors discussed above. In addition, the relevance determination module 108 may compute a plurality of relevance scores for each of the other users, which may be mapped to have different graphical attributes. By way of particular example, messages that have been sent directly to the first user may be weighted more heavily than messages that have been indirectly sent to the first user. In addition, messages that have been sent more recently may be weighted more heavily than messages that have been sent further in the past.

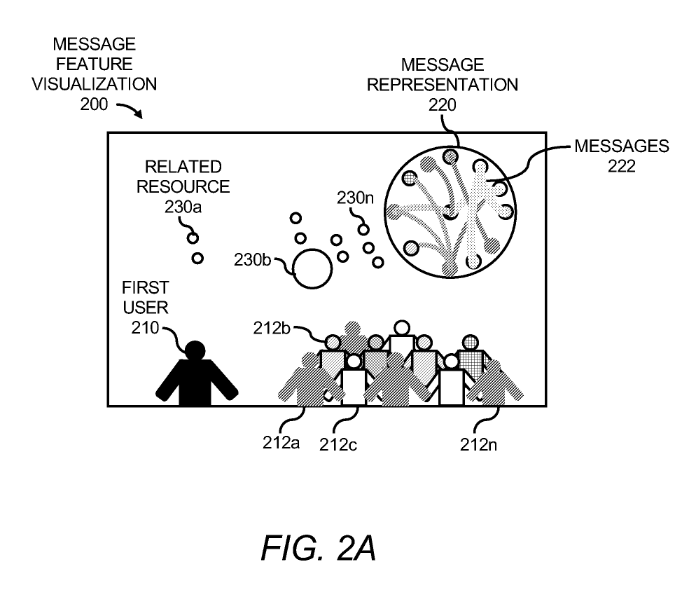

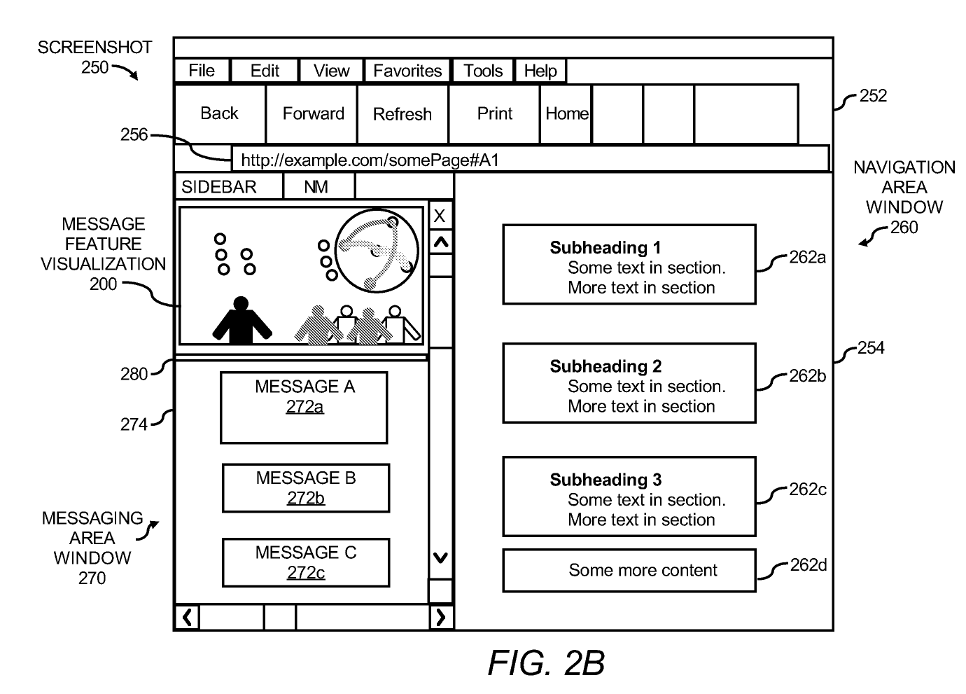

The user graphical representation module 110 is configured to create a graphical representation of the first user and the plurality of other users, such that at least one attribute, for example the horizontal position, of other users with respect to the first user, is based upon their respective scores. In this example, the user graphical representation module 110 places those other users having relatively higher scores in relatively closer proximity to the first user as compared with those other users having relatively lower scores. An example of a manner in which the user graphical representation module 110 may position the graphical representations of the other users with respect to the first user is depicted in FIG. 2A.

FIG. 2A, more particularly, depicts a diagram of a message feature visualization 200, according to an example. It should be understood that the message feature visualization 200 may include additional graphical representations and that some of the graphical representations shown herein may be removed and/or modified without departing from the scope of the message feature visualization 200.

As shown in FIG. 2A, at least one attribute of the graphical representation of the first user 210 differs from the graphical representations of the other users 212a-212n. The at least one attribute shown in FIG. 2A is that the color and the size of the first user differs from the other users 212a-212n. Other attribute differences may include different shapes, graphical representations containing different text, different shading, various distinguishing clothing, different size, etc. In any regard, through the at least one attribute difference, the first user 210 is readily distinguishable from the other users 212a-212n.

In addition, at least one attribute of the graphical representation of at least one of the other users 212a-212n differs from the graphical representation of at least one other user 212a-212n. Similar to the attribute differences for the first user 210, the attribute differences for the other users 212a-212n may also include different shapes, graphical representations containing different text, different shading, various distinguishing clothing, different sizes, etc. According to an example, the attributes given to the graphical representations of each of the other users 212a-212n may remain consistent regardless of the topic upon which the message feature visualization 200 is created. The user graphical representation module 110 may assign consistent attributes to the other users 212a-212n by using substantially unique features of the other users in assigning the attributes to them.

By way of particular example, the user graphical representation module 110 may use at least part of the other users' 212a-212n email addresses to assign the attributes. For instance, the first letters of the users' email addresses may correlate to a particular color, the second letters may correlate to a particular shade of color, etc. As another example, the hash of the users' email may correlate to a particular color or pattern.

As further shown in FIG. 2A, the other users 212a-212n are depicted as being located at various distances away from the first user 210. In the example shown therein, the relevance of each of the other users 212a-212n to the first user 210 is depicted by the distance that the other users 212a-212n are positioned from the first user 210. More particularly, for instance, those other users 212a-212n that are positioned with a lower radial distance from the first user 210 are considered to have higher levels of relevance with respect to the first user 210. In a more complex alternative, the computed relevance is multi-dimensional and different relevance measures are mapped to different visual attributes. For example, the relevance of each other user 212a-212n with respect to the first user 210 for the current topic may be depicted by varying their size, while the distance from the first user 210 may be based on their relevance to the first user 210 with respect to all topics.

With reference back to FIG. 1, in addition to the relevance of the other users 212a-212n to the first user 210, the relevance determination module 108 obtains information pertaining to the messages themselves. More particularly, for instance, the relevance determination module 108 collects information pertaining to the senders and direct recipients of the messages, the senders and indirect recipients of the messages, the dates and times when the messages were either sent or received, etc.

The message graphical representation module 112 is configured to create a graphical representation of the information pertaining to the messages, such that, the graphical representation depicts the senders and recipients of the messages. According to an example, the graphical representation is also configured to graphically depict the ages of the messages. The message feature visualization 200 depicted in FIG. 2A shows an example of a manner in which the message graphical representation module 112 may depict the messages to show the senders and the recipients of the messages along with an indication of when the messages were sent.

As shown in FIG. 2A, the message feature visualization 200 is depicted as also including a message representation 220. The message representation 220 includes a large circle in which graphical representations of both the messages 222 and the users 210, 212a-212n are contained. The users 210, 212a-21 2n are represented as circles and the messages 222 are represented as respective lines from one of the users 210, 212a-212n to at least one other user 210, 212a-212n. In addition, the circles representing the users 210, 212a-212n are shown as having similar attributes to the graphical representations of the users depicted in the message feature visualization 200. That is, for instance, the circles may have the same colors as their corresponding user 210, 212a-212n graphical representations.

As shown in FIG. 2A, the circle representing the first user 210 is depicted as being centrally located in the large circle and the circles representing the other users 212a-212n are located around the periphery of the large circle. According to an example, the positions at which the circles corresponding to the other users 212a-212n are located around the large circle may be a function of data pertaining to the other users 212a-212n. By way of example, the locations of the users 212a-212n around the circle may be based upon their respective email addresses. As such, the locations of the other users 212a-212n will remain substantially constant across conversations pertaining to multiple topics.

As another example, the locations of the other users 212a-212n may be based upon their organizational groups. In this example, the circles representing the other users 212a-212n of a particular organizational group may be arranged in one section of the large circle while other users 212a-212n are arranged in different sections of the large circle. As a further example, some of the other users 212a-212n may be positioned outside of the large circle to denote that those other users 212a-212n are outside of the organization. By maintaining this distinction among the other users 212a-212n, the first user 210 may relatively easily and quickly identify the particular people that the circles represent.

As further shown in the message representation 220, each of the messages 222 are depicted as Bezier curves originating at one user and ending at another user 210, 212a-212n. In addition, although not explicitly depicted, the messages 222 may comprise attributes that are similar to those of the senders of the messages 222 to thereby readily distinguish the senders and the recipients of the messages 222. Moreover, the messages 222 that connect the central circle pertaining to the first user 210 to a circle representing another user 212a-212n represent messages that have been directly either sent from or received by the first user 210. The messages 222 that do not connect to the central circle represent those messages that have been indirectly received by the first user 210, for instance, those messages for which the first user 210 was only carbon-copied.

The messages 222 are also depicted as having various thicknesses and transparencies. According to an example, the message graphical representation module 112 is configured to vary one or both of the thickness and the transparency of the messages 222 as a function of time. Thus, for instance, those messages 222 that have been sent relatively recently may have a thinner, more opaque appearance. Likewise, those messages 222 that have been sent some time ago may have a thicker, more transparent appearance.

With reference back again to FIG. 1, in addition to the features discussed above, the relevance determination module 108 obtains information pertaining to at least one resource related to the identified topic. The resources may be considered as additional topics that are related to the identified topic. For example, an additional topic may be considered to be related to the identified topic if it is cited in the same message.

The relevance determination module 108 is further configured to determine respective relevance levels of the related resources identified in the messages to the first user 210. The relevance determination module 108 may determine the respective relevance levels of the related resources based upon a combination of factors. These factors include, for instance, how frequently the related resources are mentioned in the messages sent to the first user, whether the first user 210 is a direct sender or recipient of the messages containing the related resources, when the messages containing the related resources were sent, the relevance of the other user who sent the message containing the related resources, whether the related resources are contained in messages stored in other sections of the first user's computing device, whether the related resources are contained in any messages sent by other users, the number of times the related resources are contained in messages that contain the identified topic, the existence of the related resources in a page currently being viewed, whether the related resources are linked between multiple pages, the relevance of the related resources to the identified topic, etc. The relevance determination module 108 may also use a weighted combination of these factors in determining the relevance levels of the related resources.

The relevance determination module 108 may also determine relevance of the related resources to the identified topic based upon how close a URL of the related resource is to the URL of the identified topic. For instance, the closer the URL of the related resource, the more relevant that related resource is considered to be to the identified topic, and thus, the more relevant that related resource is considered to be to the first user 210.

In any regard, the resource graphical representation module 114 is configured to create graphical representations of the resources considered to be related to the identified topic. According to an example, the resource graphical representation module 114 is configured to depict the graphical representations of the related resources to have at least one attribute according to their respective relevance levels to the first user 210. The resource graphical representation module 114 may also depict the graphical representations of the related resources to have at least one attribute according to their respective relevance levels to the identified topic. The resource graphical representation module 114 may further depict the graphical representations to have at least one attribute according to the age of the messages 222 from which the related resources were identified. The various attributes to distinguish these features may comprise, for instance, size, color, position, transparency, etc., of the related resource graphical representations.

Turning back to FIG. 2A, the message feature visualization 200 shows an example of a manner in which the resource graphical representation module 114 may depict the related resources in accordance with the description provided above. As shown therein, the related resources 230a-230n, where “n” is an integer equal to or greater than one, are positioned with respect to the first user 210 and the message representation 220.

According to an example, the radial distance from the message representation 220 denotes relevance to the identified topic and the vertical distance from the first user 210 denotes relevance to the first user 210. As such, the related resource labeled “230n” is much more relevant to the identified topic that the related resource labeled “230a”. Likewise, the related resource labeled “230b” is more relevant to the first user than the related resource labeled “230n”.

As also shown in the message feature visualization 200, the age of the messages 222 in which the related resources 230a-230n are cited have been depicted based upon the sizes of the graphical representations. Thus, for instance, the sizes of the graphical representations of the related resources 230a-230n may be reduced as the messages 222 become older. In addition or alternatively, the graphical representations may change other attributes, such as color, transparency, or location with the passage of time.

The output module 116 is configured to receive the graphical representations generated by the modules 110-114 and combine them together into a single visualization, for instance, as shown in the message feature visualization 200. In addition, the output module 116 is configured to send the message feature visualization 200 to the output interface 160, which is configured to cause the message feature visualization 200 to be displayed.

According to another example, the output module 116 is configured to produce a plurality of message feature visualizations 200 for a single topic. By way of example, the output module 116 may divide multiple message feature visualizations according to the organizations to which the other users 212a-212n belong. As another example, the message feature visualizations 200 may be divided according to the companies for which the other users 212a-212n are employed, as determined, for instance, by their respective email addresses.

According to an example, the message visualization apparatus 102 may be configured to simultaneously create multiple message feature visualizations 200 that visually depict information pertaining to multiple topics. In this example, the message visualization apparatus 102 may identify some or all of the topics contained in the messages stored in the message store 150 and create message feature visualizations 200 for each of the identified topics.

In addition, although the message feature visualization 200 may be displayed on its own, the message feature visualization 200 may be displayed as part of another application running in the visualization system 100. For instance, the message feature visualization 200 may be displayed as part of a browser display or a messaging application display. An example of this type of integration is depicted in FIG. 2B, which shows a screenshot 250 of multiple sections of a browser display.

As shown in FIG. 2B, the multiple sections include a navigation area window 260 and a messaging area window 270. The navigation area window 260 may comprise a web browser, such as, INTERNET EXPLORER, MOZILLA FIREFOX, or other type of web browser, or a file browser, such as, WINDOWS EXPLORER, or other type of file browser. In either case, the messaging area window 270 may comprise a sidebar in the navigation area window 260.

The navigation area window 260 is depicted as including a heading section 252 and a result window 254. As found in conventional web browser and file browser interfaces, the heading section 252 may include a plurality of buttons that, when selected, cause the web browser or file browser to perform any of a number of different common tasks, such as, printing, moving forward or backwards through different files, etc. In addition, the heading section 252 is depicted as including a text box 256 for receiving input from a user, such as, a URL address or a file name. The text box 256 may also display the URI of the document being displayed inside in the result window 254. In addition, the result window 254 is depicted as displaying a plurality of objects 262a-262d, which may comprise text, links to other documents, images, etc. In one regard, the objects 262a-262d may comprise one or more related resources 230a-230n.

The messaging area window 270 is depicted as displaying the message feature visualization 200 discussed above with respect to FIG. 2A. In addition, the messaging area window 270 is also depicted as optionally displaying a plurality of messages 272a-272c in a messaging window 274. The message feature visualization 200 is depicted as being separated from the messaging window 274 by a visual separator 280.

The messages 272a-272c are considered optional because the message feature visualization 200 may be generated and displayed without requiring display of the messages 272a-272c. In instances where the messages 272a-272c are displayed, the messages 272a-272c may comprise, for instance, those messages identified as either being sent from or sent to the most relevant other users 212a-212n, the newest messages, etc.

In addition, the messages 272a-272c may be configured to change based upon the first user's 210 interaction with the message feature visualization 200. For instance, the graphical representations contained in the message feature visualization 200 may comprise selectable links to the messages contained in the message store 150. By way of a particular example, selection of the current user 210 may result in statistics for all of the messages 222 that have been either sent by or received by the user to be listed in the navigation area window 274. As another example, selection of a particular other user 212a may result in all of the messages 222 that have been either sent by or received from that other user 212a to be listed in the messaging window 274.

As a further example, selection of a particular other user 212a may result in information pertaining to that user being shown in the navigation area window. That information may include, for instance, contact information, such as, email address, messages the other user 212a has sent or received, links that were included in messages they have sent or received, other people who have sent/received email to/from both that user 212a and the current user 210, etc. As a yet further example, selection of a graphical representation of a particular message 222 may result in that particular message 222 and the messages related to that particular message to be displayed in the messaging window 274. As a yet further example, selection of a graphical representation of a related resource 230a may result in the webpage or other document associated with the selected related resource 230a to be displayed in the result window 254. In addition, this selection may cause a new message feature visualization 200 to be generated based upon the selected related resources 230a comprising the identified topic.

Various manners in which the components of the system 100 depicted in FIG. 1 may be implemented are described with respect to the following figures. It should be apparent to those of ordinary skill in the art that the methods discussed below represent generalized illustrations and that other steps may be added or existing steps may be removed, modified or rearranged without departing from the respective scopes of the methods.

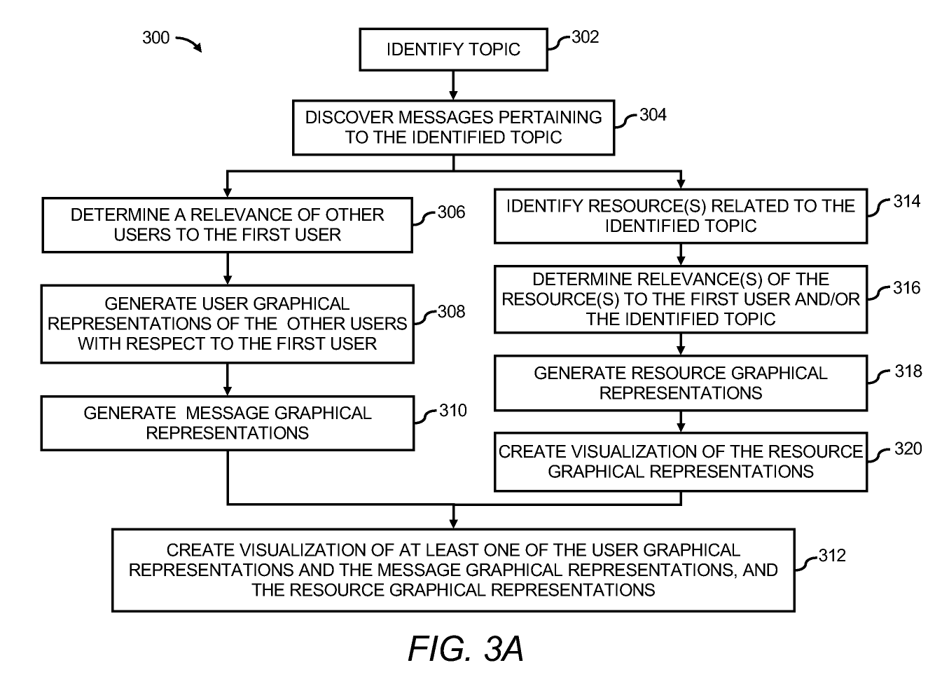

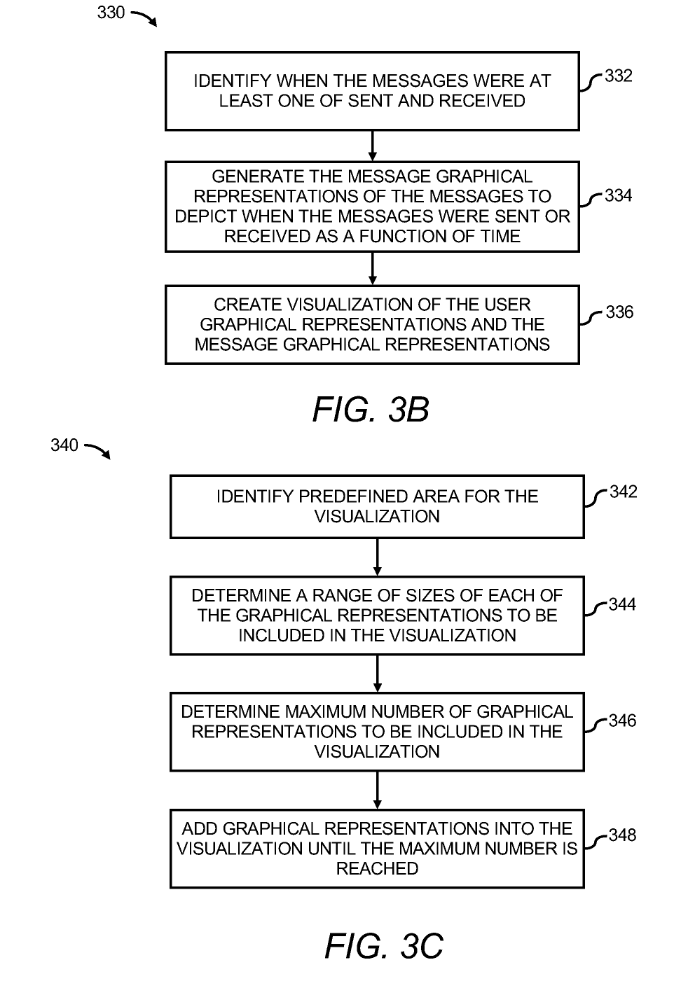

With reference first to FIG. 3A, there is shown a flow diagram of a method 300 of visualizing features of messages communicated between a first user and a plurality of other users, according to an example. Generally speaking, the message visualization apparatus 102 may implement or execute the method 300 to automatically generate a visualization of features of the messages. Alternatively, however, a differently configured visualization apparatus may be employed to execute the method 300 without departing from a scope thereof.

At step 302, the topic identifier module 104 identifies a topic. The topic may comprise a topic that is manually entered by a user, a link to a web page, a URL, the topics contained in some or all of the messages stored in a message store 150, etc. By way of example, the topic may comprise the URL of or contained in a webpage currently being viewed by the user.

At step 304, the message discovery module 106 discovers messages that have been communicated between the first user and the plurality of other users that are relevant to the identified topic. As discussed above, the messages may be stored in the message store 150 and the message discovery module 106 may access the message store 150 to discover the relevant messages.

As noted in the following steps, the message visualization apparatus 102 is configured to perform either or both of steps 306-310 and steps 314-320. In other words, the message visualization apparatus 102 is configured to create a visualization of the user graphical representations and the message graphical representations. In addition or alternatively, the message visualization apparatus 102 is configured to create a visualization of the resource graphical representations.

At step 306, the relevance determination module 108 determines a relevance of each of the plurality of other users to the first user based upon the discovered messages. The relevance determination module 108 determines the relevance of the other users based upon one or more factors including, the frequency with which the messages were sent, the number of messages that have been sent, whether the messages were sent directly to the recipients or whether the messages were indirectly sent to the recipients, such as by carbon-copying, etc. A more detailed listing of factors is discussed above.

At step 308, the user graphical representation module 110 generates user graphical representations of the other users with respect to the first user according to the determined relevance. For instance, the user graphical representation module 110 generates the user graphical representations to have at least one attribute that indicates the determined relevance. By way of particular example, the user graphical representation module 110 generates the user graphical representations such that the graphical representations of the other users are positioned at various distances from the graphical representation of the first user based upon their respective relevance to the first user. In addition, the user graphical representation module 110 generates the user graphical representations to enable differentiation among at least two of the other users.

At step 310, the message graphical representation module 114 generates message graphical representations of the messages and the senders and recipients of the messages. By way of example, the message graphical representation module 114 generates the message graphical representations as shown in FIG. 2A.

At step 312, the output module 116 creates a visualization of the user graphical representations and the message graphical representations. An example of the visualization is depicted in FIG. 2A.

In addition, or alternatively to steps 306-310, the message visualization apparatus 102 may implement steps 314-320. In the instance that the message visualization apparatus 102 implements steps 306-310, the visualization created at step 312 will include the user graphical representations and the message graphical representations. In the instance that the message visualization apparatus 102 implements steps 314-320, the visualization created at step 312 will include the resource graphical representations. In the instance that the message visualization apparatus 102 implements both sets of steps, the visualization created at step 312 will include all three of the graphical representations.

At step 314, the relevance determination module 108 identifies at least one resource related to the identified topic. Various manners in which the resource graphical representation module 114 identifies the resources related to the identified topic are discussed herein above.

At step 316, the relevance determination module 108 determines at least one relevance factor of the identified at least one resource to at least one of the first user and the identified topic. Various manners in which a resource may be considered to be related to an identified topic and in which the relevance of the identified resource(s) are determined are discussed herein above.

At step 318, the resource graphical representation module 114 generates a resource graphical representation of the resource(s) to have an attribute that is based upon the determined at least one relevance factor of the identified at least one resource to at least one of the first user and the identified topic. As discussed above, the attribute may include, for instance, size, shape, color, position, etc. of the resource graphical representations.

At step 312, the output module 116 may create the visualization to include the resource graphical representations generated at step 320. According to an example, the output module 116 may thus combine the resource graphical representations with the user and message graphical representations to create the message feature visualization 200 depicted in FIG. 2A.

Turning now to FIG. 3B, there is shown a partial flow diagram of a method 330 for visualizing features of messages, which includes steps that may be included in the method 300 depicted in FIG. 3A. The method 330, more particularly, includes a step 332 of identifying when the messages were at least one of sent from and received by the first user. In addition, at step 334, the message graphical representation module 112 generates the message graphical representations of the messages to depict an indication of when the messages have been at least one of sent and received by varying at least one attribute of the message graphical representations of the messages as a function of time. For instance, the graphical representations of the messages may be generated to fade away with the passage of time.

In addition, at step 336, which is identical to step 312 in FIG. 3A, the output module 116 creates the visualization to include the message graphical representations of the messages generated at step 334.

Turning now to FIG. 3C, there is shown a partial flow diagram of a method 340 for visualizing features of messages, which includes steps that may be included in the method 300 depicted in FIG. 3A. The method 340 may be implemented prior to, during, or following the steps contained in the methods 300 and 330.

Generally speaking, the message visualization apparatus 102 is configured to implement the method 340 display the graphical representations within a predefined area, which may include omitting some of the graphical representations generated by the modules 110-114, while having the substantially least amount of negative impact on the message feature visualization 200. Thus, for instance, the new message visualization apparatus 102 may omit those graphical representations that have been identified as being the least relevant to the first user first and then remove the more relevant graphical representations as needed to reduce the size of the message feature visualization 200 fit within an available space.

At step 342, the detail level module 118 determines a predefined area for the visualization. The predefined area for the visualization may be set by the user, by limitations in the screen size, by limitations set by the application running the message visualization apparatus 102, etc. In addition, the predefined area for a given screen size may vary depending upon other images that are concurrently displayed on the screen.

At step 344, the detail level module 118 determines a range of sizes of each of the graphical representations to be included in the message feature visualization 200. More particularly, for instance, the detail level module 118 determines a range of sizes of at least one of the user graphical representations, the message graphical representations, and the resource graphical representation. By way of example, the detail level module 118 may determine that the graphical representations are to have at least a minimum size, such that they are able to readily represent respective features of the messages while allowing for a sufficient number of graphical representations to be depicted in the message feature visualization 200.

At step 346, the detail level module 118 determines a maximum number of graphical representations to be included in the message feature visualization 200. According to an example, the detail level module 118 makes this determination based upon the range of sizes of each of the graphical representations to be included in the message feature visualization 200. Thus, for instance, the detail level module 118 may determine a higher maximum number when the range of sizes of the graphical representations is relatively small compared to the identified predefined area for the message feature visualization 200.

According to an example, the detail level module 118 is configured to convey the maximum number of the graphical representations to the relevance determination module 108. In this example, the relevance determination module 108 is also configured to convey the maximum numbers of each of the user graphical representations, the message graphical representations, and the resource graphical representations to the respective modules 110-114. In response, the modules 110-114 are configured to add their respective graphical representations into the output module 116 until the maximum number determined at step 346 is reached, as indicated at step 348. In one respect, therefore, the module 110 are configured to limit the number of graphical representations that they communicate to the output module 116 to thereby enable the message feature visualization to remain within the predefined area while displaying the most relevant information.

Alternatively, the detail level module 118 may convey the maximum number of graphical representations directly to the output module 116, which may determine which, if any, of the graphical representations to include in the message feature visualization 200 to remain within the predefined area.

Some or all of the operations set forth in the methods 300, 330, and 340 may be contained as utilities, programs, or subprograms, in any desired computer accessible medium. In addition, some or all of the methods 300, 330, and 340 may be embodied by computer programs, which may exist in a variety of forms both active and inactive. For example, they may exist as software program(s) comprised of program instructions in source code, object code, executable code or other formats. Any of the above may be embodied on a computer readable medium, which include storage devices and signals, in compressed or uncompressed form.

Exemplary computer readable storage devices include conventional computer system RAM, ROM, EPROM, EEPROM, and magnetic or optical disks or tapes. Exemplary computer readable signals, whether modulated using a carrier or not, are signals that a computer system hosting or running the computer program can be configured to access, including signals downloaded through the Internet or other networks. Concrete examples of the foregoing include distribution of the programs on a CD ROM or via Internet download. In a sense, the Internet itself, as an abstract entity, is a computer readable medium. The same is true of computer networks in general. It is therefore to be understood that any electronic device capable of executing the above-described functions may perform those functions enumerated above.

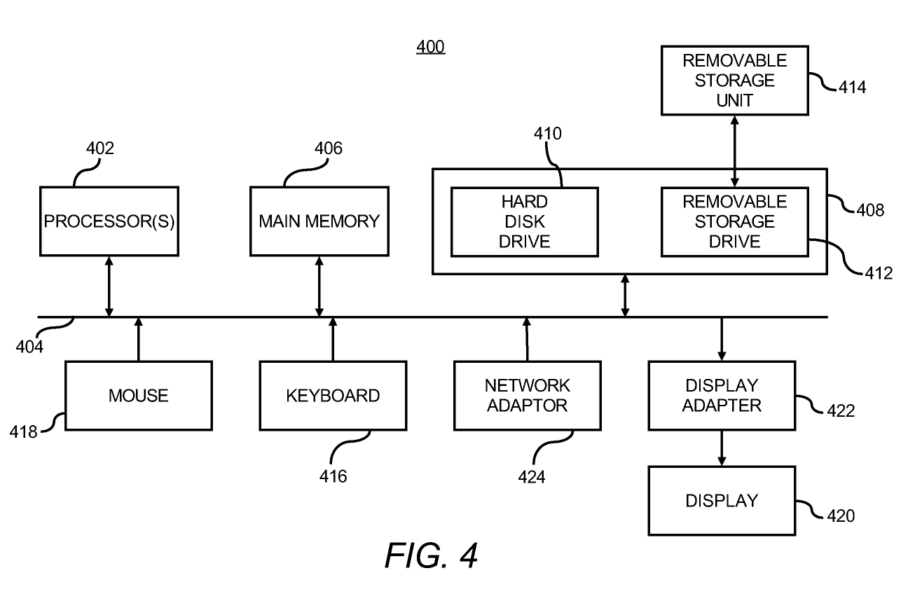

FIG. 4 illustrates a block diagram of a computing apparatus 400, such as the visualization system 100 depicted in FIG. 1, according to an example. In this respect, the computing apparatus 400 may be used as a platform for executing one or more of the functions described hereinabove with respect to the visualization system 100.

The computing apparatus 100 includes one or more processors 402. The processor(s) 402 may be used to execute some or all of the steps described in the methods 300, 330, and 340. Commands and data from the processor(s) 402 are communicated over a communication bus 404. The computing apparatus 400 also includes a main memory 406, such as a random access memory (RAM), where the program code for the processor(s) 402, may be executed during runtime, and a secondary memory 408. The secondary memory 408 includes, for example, one or more hard disk drives 410 and/or a removable storage drive 412, representing a floppy diskette drive, a magnetic tape drive, a compact disk drive, etc., where a copy of the program code for the methods 300, 330, and 340 may be stored.

The removable storage drive 410 reads from and/or writes to a removable storage unit 414 in a well-known manner. User input and output devices may include a keyboard 416, a mouse 418, and a display 420. A display adaptor 422 may interface with the communication bus 404 and the display 420 and may receive display data from the processor(s) 402 and convert the display data into display commands for the display 420. In addition, the processor(s) 402 may communicate over a network, for instance, the Internet, LAN, etc., through a network adaptor 424.

It will be apparent to one of ordinary skill in the art that other known electronic components may be added or substituted in the computing apparatus 400. It should also be apparent that one or more of the components depicted in FIG. 4 may be optional (for instance, user input devices, secondary memory, etc.).

What has been described and illustrated herein is a preferred embodiment of the invention along with some of its variations. The terms, descriptions and figures used herein are set forth by way of illustration only and are not meant as limitations. Those skilled in the art will recognize that many variations are possible within the scope of the invention, which is intended to be defined by the following claims—and their equivalents—in which all terms are meant in their broadest reasonable sense unless otherwise indicated.

What is claimed is:

1. A computerized method of visualizing features of messages communicated between a first user and a plurality of other users, said method comprising:
identifying a topic;
discovering messages relevant to the identified topic, wherein the messages are communicated between the first user and the plurality of other users;
at least one of:
determining a relevance of each of the plurality of other users to the first user, generating user graphical representations of the plurality of other users with respect to the first user according to the determined relevance, and
generating message graphical representations of the messages and senders and recipients of the messages;
and
identifying at least one resource related to the identified topic,
determining at least one relevance factor of the identified at least one resource to at least one of the first user and the identified topic, and
generating a resource graphical representation of the at least one resource to have an attribute that is based upon the determined at least one relevance factor of the identified at least one resource to at least one of the first user and the identified topic; and
creating a visualization of at least one of a combination of the user graphical representations and the message graphical representations, and the resource graphical representation.

2. The method according to claim 1, wherein generating the user graphical representations further comprises generating the user graphical representations to have at least one attribute that indicates the determined relevance of the plurality of other users with respect to the first user.

3. The method according to claim 1, wherein generating the user graphical representations further comprises assigning a first graphical attribute to the user graphical representation of at least one of the plurality of other users and assigning a second graphical attribute to the user graphical representation of at least another one of the plurality of other users.

4. The method according to claim 1, further comprising:
identifying when each of the messages were at least one of sent and received by the first user; and
wherein generating the message graphical representations further comprises generating the message graphical representations of the message to depict an indication of when the messages have been at least one of sent and received by varying at least one attribute of the message graphical representations of the messages as a function of time.

5. The method according to claim 1, wherein identifying a topic further comprises identifying at least one of an identifier of a web page and an identifier cited in a message.

6. The method according to claim 1, wherein determining a relevance of each of the plurality of other users to the first user based upon the messages further comprises determining the relevance based upon a weighted combination of a plurality of factors, wherein the plurality of factors include at least one of the frequency with which the messages have been communicated between the first user and respective ones of the plurality of other users, the number of times the messages have been sent between the first user and respective ones of the plurality of other users, and whether the messages were sent between the first user and respective ones of the plurality of other users directly or indirectly, when the messages were sent, and whether the first user created the messages.

7. The method according to claim 1, wherein determining at least one relevance factor of the identified at least one resource to at least one of the first user and the identified topic further comprises determining the relevance based upon a weighted combination of a plurality of factors, wherein the plurality of factors include at least one of, how frequently the related resources are mentioned in the messages sent to the first user, whether the first user is a direct sender or recipient of the messages containing the related resources, when the messages containing the related resources were sent, the relevance of the other user who sent the message containing the related resources, whether the related resources are contained in messages stored in other sections of the first user's computing device, whether the related resources are contained in any messages sent by other users, the number of times the related resources are contained in messages that contain the identified topic, the existence of the related resources in a page currently being viewed, whether the related resources are linked between multiple pages, and the relevance of the related resources to the identified topic.

8. The method according to claim 1, further comprising:
identifying a predefined area for the visualization;
determining a range of sizes of at least one of the user graphical representations, the message graphical representations, and the resource graphical representation;
determining a maximum number of at least one of the user graphical representations, the message graphical representations, and the resource graphical representation to be included in the visualization based upon the predefined area and the determined ranged of sizes; and
wherein creating the visualization further comprises adding at least one of the combination of the user graphical representations and the message graphical representations, and the resource graphical representation into the visualization until the maximum number is reached.

9. The method according to claim 1, wherein discovering messages relevant to the identified topic further comprises discovering messages relevant to the identified topic from messages stored locally on a computing device of the first user.

10. The method according to claim 1, wherein generating a resource graphical representation further comprises generating the resource graphical representation of the at least one resource to have a plurality of attributes that depict multiple dimensions of features of the at least one resource.

11. An apparatus for visualizing features of messages between a first user and a plurality of other users, said apparatus comprising:
a topic identifier module configured to identify a topic;
a message discovery module configured to discover messages contained in a message store that are relevant to the identified topic;
a relevance determination module configured to determine at least one of:
a relevance of each of the plurality of other users to the first user based upon the messages; and
at least one relevance factor of the identified at least one resource to at least one of the first user and the identified topic; and
at least one of:
a user graphical representation module configured to graphically represent the plurality of other users with respect to the first user according to the determined relevance of each of the plurality of other users to the first user, and
a message graphical representation module configured to graphically represent senders and recipients of the messages; and
a resource graphical representation module configured to graphically represent the at least one resource to have an attribute that is based upon the determined relevance of the identified at least one resource to the first user; and
an output module configured to create a visualization of at least one of a combination of the user graphical representations and the message graphical representations, and the resource graphical representation.

12. The apparatus according to claim 11, wherein the message graphical representation module is further configured to graphically visualize when the messages have been at least one of sent and received by varying at least one attribute of the graphical representations of the messages as a function of time.

13. The apparatus according to claim 11, further comprising:
a detail level module configured to determine a predefined area for the message feature visualization, to determine a range of sizes of at least one of the user graphical representations, the message graphical representations, and the resource graphical representation, to determine a maximum number of at least one of the user graphical representations, the message graphical representations, and the resource graphical representation to be included in the visualization based upon the predefined area and the determined ranged of sizes, and wherein the detail level module is further configured to add at least one of the combination of the user graphical representations and the message graphical representations, and the resource graphical representation into the visualization until the maximum number is reached.

14. A computer readable storage medium on which is embedded one or more computer programs, said one or more computer programs implementing a method of visualizing features of messages communicated between a first user and a plurality of other users, said one or more computer programs comprising a set of instructions for:
identifying a topic;
discovering messages relevant to the identified topic, wherein the messages are communicated between the first user and the plurality of other users;
at least one of:
determining a relevance of each of the plurality of other users to the first user based upon the discovered messages,
generating user graphical representations of the plurality of other users with respect to the first user according to the determined relevance, and
generating message graphical representations of the messages and senders and recipients of the messages;
and
identifying at least one resource related to the identified topic,
determining at least one relevance factor of the identified at least one resource to at least one of the first user and the identified topic, and
generating a resource graphical representation of the at least one resource to have an attribute that is based upon the determined at least one relevance factor of the identified at least one resource to at least one of the first user and the identified topic; and
creating a visualization of at least one of a combination of the user graphical representations and the message graphical representations, and the resource graphical representation.

15. The computer readable storage medium according to claim 14, said one or more computer programs comprising a set of instructions for:
identifying a predefined area for the visualization;
determining a range of sizes of at least one of the user graphical representations, the message graphical representations, and the resource graphical representation;
determining a maximum number of at least one of the user graphical representations, the message graphical representations, and the resource graphical representation to be included in the visualization based upon the predefined area and the determined ranged of sizes; and
wherein creating the visualization further comprises adding at least one of the combination of the user graphical representations and the message graphical representations, and the resource graphical representation into the visualization until the maximum number is reached.
